(19) United States
(12) Patent Application Publication
(10) Pub. No.: US 2002/0102961 A1
(43) Pub. Date: Aug. 1, 2002

(54) Emergency vehicle warning system

(76) Inventors: Richard Gibbons, Mundelein, IL (US); John Gibbons, Park Ridge, IL (US)

Correspondence Address: Robert J. Depke, MAYER, BROWN & PLATT, P.O. Box 2828, Chicago, IL, 60690-2828, US

(21) Appl. No.: 09/774,385

(22) Filed: Jan. 30, 2001

(51) Int. Cl. H04M 11/00

(52) U.S. Cl. 455/404; 455/42; 455/70; 455/68

(57) ABSTRACT

Systems and methods for transmitting signals concerning the location of an emergency vehicle to other cars traveling in the vicinity of the emergency vehicle alert the other vehicles to the presence of the emergency vehicle. A transmitter unit which is desirably automatically switched on whenever the flashing lights and sirens of the emergency vehicle are activated. transmits a signal preferably only within a limited range adjacent or near the emergency vehicle. The transmitted signal preferably identifies the present location and direction of the emergency vehicle. The location and direction information of the emergency vehicle is preferably provided by GPS data generated by a GPS system associated with the emergency vehicle. Automobiles and other vehicles are outfitted with receivers for receiving the signals transmitted by emergency vehicles as described above. Once a signal is received which indicates that an emergency vehicle is operating nearby, the receiver unit processes the signal and then ultimately triggers an alert to the mechanism that is in the vehicle and may be included within the receiver unit. The alert mechanism may be comprised of a flashing light or an audible tone or a recorded message that plays back a statement that indicates the presence of the emergency vehicle nearby.

### BACKGROUND OF THE INVENTION

1. Field of the Invention

The present invention relates generally to the field of automated sensing devices and emergency vehicle alert systems. More specifically, the present invention is directed to an automobile emergency vehicle sensing system which alerts drivers of vehicles traveling in a region near an emergency vehicle to the fact that an emergency vehicle is nearby with its warning devices operating.

2. Description of the Related Art

Currently, emergency vehicles such as, for example, fire engines, police cars, and ambulances rely upon some combination of flashing lights, sirens and/or horns in order to alert drivers traveling in automobiles operating near the emergency vehicle that the emergency vehicle is nearby. The purpose of these warning mechanisms is to alert drivers so that they may pull to the side of the road and allow the emergency vehicle to safely pass.

Additionally, these signaling devices are used in order to alert other drivers of the presence of the emergency vehicle. The emergency vehicles may be traveling in the opposite direction at a high rate of speed and the signaling devices are intended to alert other drivers so that they may pull to the side of the road and provide the emergency vehicle with plenty of room to maneuver or make turns. Furthermore, when an emergency vehicle is stopped at a particular location, the warning devices alert other drivers to potential dangers and the need to use caution in order to avoid hitting any emergency personnel or other obstacles which may be present at a crash site or other emergency vehicle destination.

Unfortunately, even when emergency vehicles have used these conventional signaling devices, there have been many instances in recent years where emergency vehicles have been involved in accidents with other vehicles and/or other vehicles have caused emergency vehicles to otherwise crash because the existing flashing lights and sirens utilized by the emergency vehicle were insufficient to alert the other drivers of the presence of the emergency vehicle.

In some instances, drivers of other vehicles have failed to notice the flashing lights, sirens and/or horns of emergency vehicles operating nearby because the driver was listening to the radio in the automobile at a very high-volume. As a result the driver was unable to hear the sirens of the emergency vehicle resulting in a crash with emergency vehicle. This is particularly problematic for vehicles traveling in the winter when the windows on the car are closed or in the summer when automobile air conditioners are used. In these instances it is much easier for the internal car radio to overwhelm the volume of the sirens until the emergency vehicle is very close.

In other instances of crashes involving emergency vehicles, the drivers of other vehicles have simply failed to notice the warning signals associated with the emergency vehicle possibly due to the impairment or disability and of the driver. In yet other instances it is likely that drivers were aware of the emergency vehicle but intentionally chose not to reduce their speed and pull to the side of the road as required. As a result of these problems, there have recently been many instances of automobile crashes involving emergency vehicles. These crashes have often had devastating consequences and resulted in the death or serious injury of the automobile drivers or the fireman and policemen traveling in or working near the emergency vehicles. Accordingly, there remains a need in the field for improved warning mechanisms which will alert automobile drivers to the presence of an emergency vehicle traveling nearby.

It is one object of the present invention to provide an improved emergency vehicle warning system to alert automobile drivers to the presence of an emergency vehicle traveling nearby. It is another object of the present invention to provide an improved emergency vehicle warning system which is simple to implement and which may be readily recognized by an automobile driver. It is yet another object of the present invention to provide an improved emergency vehicle warning system which can be easily retrofitted into existing automobiles without substantial expense. Other objects and advantages of the present invention will be apparent in light of the following summary and detailed description of the presently preferred embodiments.

### SUMMARY OF THE INVENTION

The present invention relates generally to an automated system for alerting automobile drivers to the fact that an emergency vehicle is near the automobile. Specifically, the present invention is directed to a system for automatically providing an indication to an automobile driver regarding the presence of emergency vehicle which may be recognized before the flashing lights of the emergency vehicle are visible or the sirens and/or horns can be heard. As noted above, one of the problems with the existing mechanisms for alerting drivers as to the presence of an emergency vehicle operating nearby is that they have a limited range of transmission which can be obstructed by other vehicles or barriers adjacent to the roadway. Additionally, the audible alarms associated with the emergency vehicle such as horns and/or sirens may be obscured by a loud radio and/or other road noise. Furthermore, these audible signals may be significantly diminished when a driver has the windows of the vehicle closed.

The systems and methods of the present invention overcome the shortcomings of the prior art by providing systems and methods for transmitting signals concerning the location of an emergency vehicle to other cars traveling in the vicinity of the emergency vehicle so that these other vehicles may be alerted to the presence of the emergency vehicle, possibly even prior to hearing and/or seeing other audible or visual alert signals directly associated with the emergency vehicle.

In a first preferred exemplary embodiment of the present invention, an emergency vehicle has a transmitter unit which is desirably automatically switched on whenever the flashing lights and sirens of the emergency vehicle are activated. The transmitter unit transmits a signal preferably only within a limited range adjacent or near the emergency vehicle. Specifically, in one exemplary embodiment, a low power FM transmitter is used to transmit this alert signal to vehicles traveling in the general vicinity of the emergency vehicle. For example, this distance may be selected to be a radius of approximately one mile or some other desired distance. This can readily be accomplished by selecting a relatively low power output and thus inexpensive transmitter. A low-power FM transmitter operating in a frequency range in or near the FM broadcast range is preferred in order to provide the desired low-range transmission. However, it will be recognized that other types of modulation and frequency bands will work also.

The transmitted signal may be comprised of simple tones and/or an audible verbal message which could identify the present location and direction of the emergency vehicle. In an alternate exemplary embodiment the transmitted signal may be comprised of a signal containing digital information which is automatically generated in order to provide more specific information concerning the emergency vehicle, such as its specific location and/or direction of travel. In such an embodiment, the location and direction information of the emergency vehicle is preferably provided by GPS data generated by a GPS system associated with the emergency vehicle.

Regardless of the type of signal which is sent by the transmitting unit, it is preferred that the transmission be relatively low power so that only cars within a reasonable distance of emergency vehicle may receive the signal indicating presence of the emergency vehicle operating nearby. It will be readily recognized by those skilled in the art that it is unnecessary to broadcast information regarding the presence of an emergency vehicle operating at distances of greater than a mile because this information is typically not particularly relevant to other vehicles at distances of more than a mile.

In accordance with the preferred exemplary embodiment, automobiles and other vehicles are outfitted with receivers for receiving the signals transmitted by emergency vehicles as described above. The receiver units may be incorporated into new automobile or vehicle radios or may be comprised of an additional receiving unit that may be located somewhere in the vehicle. In order to easily retrofit existing vehicles, a separate receiving unit can easily be incorporated into a vehicle by providing power from a cigarette lighter as is known in the art. When a separate receiving unit is utilized, a low-cost receiver is preferably utilized in order to limit costs and increase the ease with which this system may be accepted by the general public.

Regardless of the type of receiver unit which is employed by the system, once a signal is received which indicates that an emergency vehicle is operating nearby, the receiver unit processes the signal and then ultimately triggers an alert mechanism that is in the vehicle and may be included within the receiver unit. For example, this alert mechanism may be comprised of a flashing light or an audible tone or a recorded message that plays back a statement that indicates the presence of the emergency vehicle nearby.

In the preferred exemplary embodiment, the receiver unit is linked with any conventional radio receiver or audio system used in the automobile. This is desirable so that the volume of the radio or audio system may be automatically adjusted whenever a signal is received that indicates the presence of the emergency vehicle. This reduction in volume in and of itself may also be useful as an alert signal to be used in helping to more quickly identify the presence of the emergency vehicle. After the distance between the vehicle and the emergency vehicle increases again, the audio system preferably automatically resets to its previous operating condition.

In one preferred exemplary embodiment, when such a receiver in a vehicle operating near an emergency vehicle receives a signal transmitted from the emergency vehicle, a flashing light within the signal receiving vehicle may be used to indicate the presence of the emergency vehicle. Depending upon the selected radius or distance of transmission for the transmitting unit, this alert signal may be provided well before the time at which a driver is able to see flashing lights or hear a siren associated with the emergency vehicle. As noted above, this internal visual alert may also be used in conjunction with other audible alarms in the car in order to alert the driver of the presence of an emergency vehicle.

In the preferred exemplary embodiment, the flashing light is preferably one of varying brightness or alternatively it's flash repetition rate in order to help a driver to ascertain the distance to the emergency vehicle. In such embodiment, the brightness of the light or the more rapid flashing rate of the light will indicate that the emergency vehicle is closer. Alternatively and/or in conjunction with the flashing light, an audible alarm integral to the vehicle will be activated to indicate to the driver that an emergency vehicle is traveling nearby. The audible alarm may be a voice recording and/or any other type of audible signal. In an alternate preferred embodiment, a faster blinking of a flashing light or a louder tone of the signal will indicate a closer proximity for the emergency vehicle, thereby indicating to the driver that there is a more immediate need to pull to the side of the road and allow the vehicle to pass by safely.

In such an embodiment, the relative signal strength of the signal received from the emergency vehicle is utilized in approximating the relative distance between the emergency vehicle and the automobile. Calibration of the system can also be used to specifically identify approximate distances whereby a signal having a particular signal strength or range of signal strengths will indicate the emergency vehicle is within approximately a specified range. Specifically, for example, the system may specify quarter-mile increments or possibly either approximate fixed distances to the emergency vehicle.

In an alternate embodiment, the systems and methods of the present invention rely upon cellular telephone transmitters or other base stations with receiving units whereby preferably specific cell towers or base stations near the emergency vehicle will transmit signals concerning the presence of an emergency vehicle to other vehicles equipped with signal receivers traveling near the base station or cell tower. The receive units in the other vehicles may also be connected with the conventional radio of the car such that the audio volume of the radio or other audio device may be automatically reduced in order to prevent a driver from accidentally missing the audio signal indicating that an emergency vehicle is traveling nearby. In such a system, the emergency vehicle transmits location information to base station locations, such as, for example, cell towers. The base station location then retransmits the location information to other vehicles as described above. The receiver unit then triggers the audio system mute.

It will be appreciated that a variety of alternate types of transmitters may be used, however, it is preferred that an FM transmitter is used for transmission of the necessary signals operating near the FM broadcast band as noted. In embodiments which transmit direction and location information to other vehicles it is preferred that a GPS system is associated with the emergency vehicle be used to provide information regarding the specific location of the vehicle and its direction of travel. Thus, this information can be specifically transmitted to nearby vehicles thereby alerting them as to the presence of the vehicle.

This is particularly advantageous as vehicles that are within a particular range but which are not in the path of the emergency vehicle can automatically disregard signals transmitted by the emergency vehicle. For example, if a vehicle has just passed an intersection traveling northbound and the emergency vehicle thereafter enters the intersection and begins traveling southbound on the same street, the vehicle would be able to receive and process signals containing information regarding the direction and location of the emergency vehicle but would be able to disregard this information and avoid unnecessarily alerting the driver of the vehicle regarding the presence of the emergency vehicle. This embodiment also requires GPS data or other specific location and direction information of the vehicle.

Additionally, this exemplary embodiment of the system is able to determine if an emergency vehicle is traveling on a particular roadway which may not be a concern to the driver. For example, if the emergency vehicle is traveling on a parallel roadway, the system would be able to determine based on the location information that it is unnecessary to generate a warning signal within the vehicle. In this exemplary embodiment of the present invention, GPS information generated by both adjacent vehicles and the emergency vehicle may be compared such that irrelevant warnings may be automatically disregarded by the system.

In a further alternate exemplary embodiment, the location information transmitted by the emergency vehicle is also received at base stations which transmit this information to further processing systems or stations which use the current location and direction information of the emergency vehicle in conjunction with routing information for the emergency vehicle so that traffic lights in the path of the emergency vehicle may be manipulated to provide more rapid transit for the emergency vehicle. Specifically, in this embodiment, one or more base station units provide receivers which receive the current location and direction information for an emergency vehicle preferably based on existing GPS data for the vehicle. A main processing center acquires this data as well as predetermined routing information for the emergency vehicle. Based on the current direction and location information for the emergency vehicle, the system is able to identify the appropriate lights to sequence in order to more quickly allow for transit of the emergency vehicle. This is due to the fact that the system has access to route information for the emergency vehicle. Additionally, the system has access to information identifying the locations of traffic lights in the path of the emergency vehicle and is therefore able to trigger traffic lights at the appropriate time in order to allow the emergency vehicle to more quickly travel to its destination. Specifically, for example, in this embodiment, if an emergency vehicle is traveling down street A in a given city with lights at intersections 1, 2, 3, 4 with street A, the traffic lights can be triggered at the appropriate time in order to assure the traffic has cleared a path for the emergency vehicle thereby allowing the emergency vehicle to more quickly reach its desired destination.

A variety of systems and methods are disclosed for implementation of the present invention. It will be understood by the those skilled in the art that a variety of substitutions are possible. For example alternate location information generating systems may be used such as, for example, inertial navigation and Loran type systems. Additionally, other types of receivers and transmitters may be used by the system. The following detailed description of the preferred exemplary embodiments sets forth the presently preferred embodiments of the present invention.

### BRIEF DESCRIPTION OF THE DRAWINGS

FIG. 1 illustrates a first exemplary embodiment of the systems and methods of the present invention;

FIG. 2 illustrates a second exemplary embodiment of the systems and methods of the present invention;

FIG. 3 illustrates a third exemplary embodiment of the systems and methods of the present invention;

FIG. 4 illustrates a fourth exemplary embodiment of the systems and methods of the present invention;

FIG. 5 illustrates a fifth exemplary embodiment of the systems and methods of the present invention; and

FIG. 6 illustrates a further alternate exemplary embodiment of the systems and methods of the present invention.

### DETAILED DESCRIPTION OF THE PRESENTLY PREFERRED EMBODIMENTS

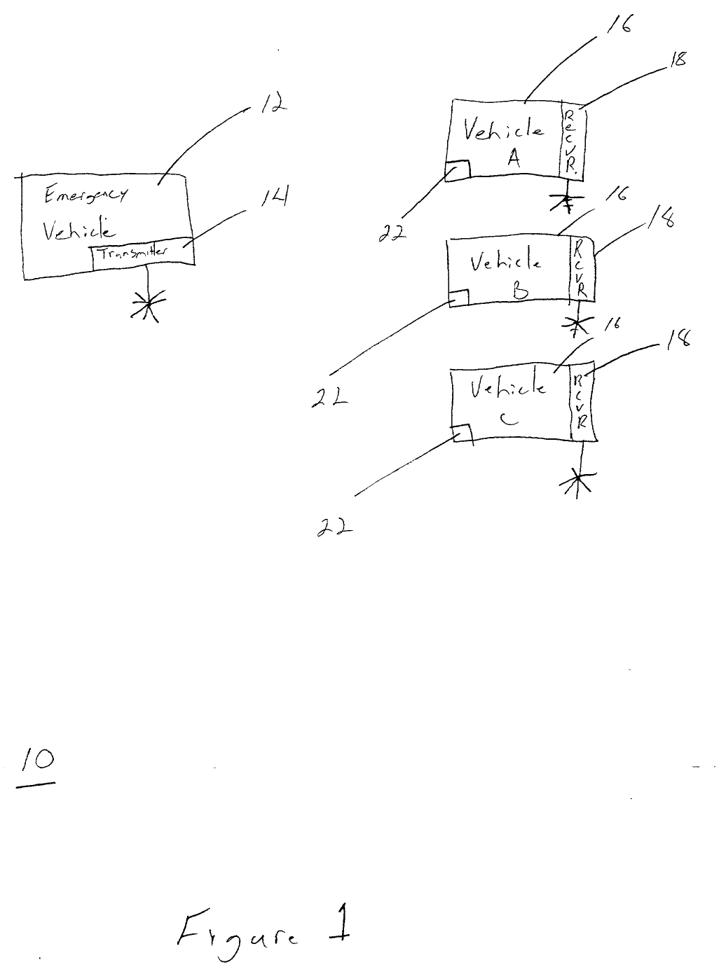

FIG. 1 illustrates a first exemplary embodiment of one system for implementation of the systems and methods of the present invention which is shown generally at 10. The emergency vehicle location system of the present invention overcomes the shortcomings of the prior art by providing systems and methods for transmitting signals concerning the location of an emergency vehicle to other cars traveling in the vicinity of the emergency vehicle so that these other vehicles may be alerted to the presence of the emergency vehicle, possibly even prior to hearing and/or seeing other audible or visual alert signals directly associated with the emergency vehicle.

In the first preferred exemplary embodiment of the present invention, an emergency vehicle 12 has a transmitter unit 14 which is desirably automatically switched on whenever the flashing lights and sirens of the emergency vehicle are activated. The transmitter unit 14 transmits a signal preferably only within a limited range adjacent or near the emergency vehicle. Specifically, in one exemplary embodiment, a low power FM transmitter is used to transmit this alert signal to vehicles traveling in the general vicinity of the emergency vehicle. For example, this distance may be selected to be a radius of approximately one mile or some other desired distance. Those skilled in the art will appreciate that a variety of factors can impact the approximate transmission range for such a transmitter. For example, the transmission power, antenna characteristics, and location of the antenna are all relevant factors for adjusting the relative transmission distance. Accordingly, achieving a short-range transmission can be accomplished by selecting a relatively low power and inexpensive transmitter. A low-power FM transmitter operating in a frequency range in or near the FM broadcast range is preferred in order to provide the desired low-range transmission.

The transmitted signal may be comprised of simple tones and/or an audible verbal message which identifies the present location and direction of the emergency vehicle. A vehicle 16 traveling near the emergency vehicle 12 includes a receiver unit 18 for receiving signals transmitted regarding the presence of a nearby emergency vehicle. As described below, in an alternate exemplary embodiment the transmitted signal may be comprised of a signal containing digital information which is automatically generated in order to provide more specific information concerning the emergency vehicle such as its specific location and/or direction of travel. In such an embodiment, the location and direction information of the emergency vehicle is preferably provided by GPS data generated by a GPS system associated with the emergency vehicle.

Regardless of the type of signal which is sent by the transmitting unit, it is preferred that the transmission be relatively low power so that only cars within a reasonable distance of emergency vehicle may receive the signal indicating presence of the emergency vehicle operating nearby. It will be readily recognized by those skilled in the art that it is unnecessary to broadcast information regarding the presence of an emergency vehicle operating at distances of greater than a mile because this information is not particularly relevant.

In accordance with the preferred exemplary embodiment, automobiles and other vehicles are outfitted with the receiver units 18 for receiving the signals transmitted by emergency vehicles as described above. The new receiver units may be incorporated into a new automobile or vehicle radios or may be comprised of an additional separate receiving unit. In order to easily retrofitted existing vehicles, a separate receiving unit can easily be incorporated into a vehicle by providing power from a cigarette lighter as is known in the art. Receiving unit 18 would include the receiver tuned to the appropriate frequency for reception of any signals generated by emergency vehicles or base stations which are transmitting signals identifying the presence of any nearby emergency vehicles. The actual frequency of transmission and type of modulation will be selected by convention. Those skilled in the art will recognize that uniformity is important for acceptance and maximum useful coverage of the systems. When a separate receiving unit is utilized, a low-cost receiver is preferably utilized in order to limit costs and increase the ease with which this system may be accepted by the general public.

Regardless of the type of receiver unit which is employed by the system, once a signal is received which indicates that an emergency vehicle is operating nearby, the receiver unit processes the signal and then ultimately triggers an alert mechanism 22 that is in the vehicle and may be included within the receiver unit. It will be recognize that this alert mechanism 22 may also be separated from the receiving unit. This alert mechanism 22 may be comprised of a flashing light or an audible tone or a recorded message that plays back a statement that indicates the presence of the emergency vehicle nearby. When the alert mechanism is separated from the receiving unit 18, the alert mechanism 22 will be linked to the receiver unit 18 by either wires or an infrared transmission link.

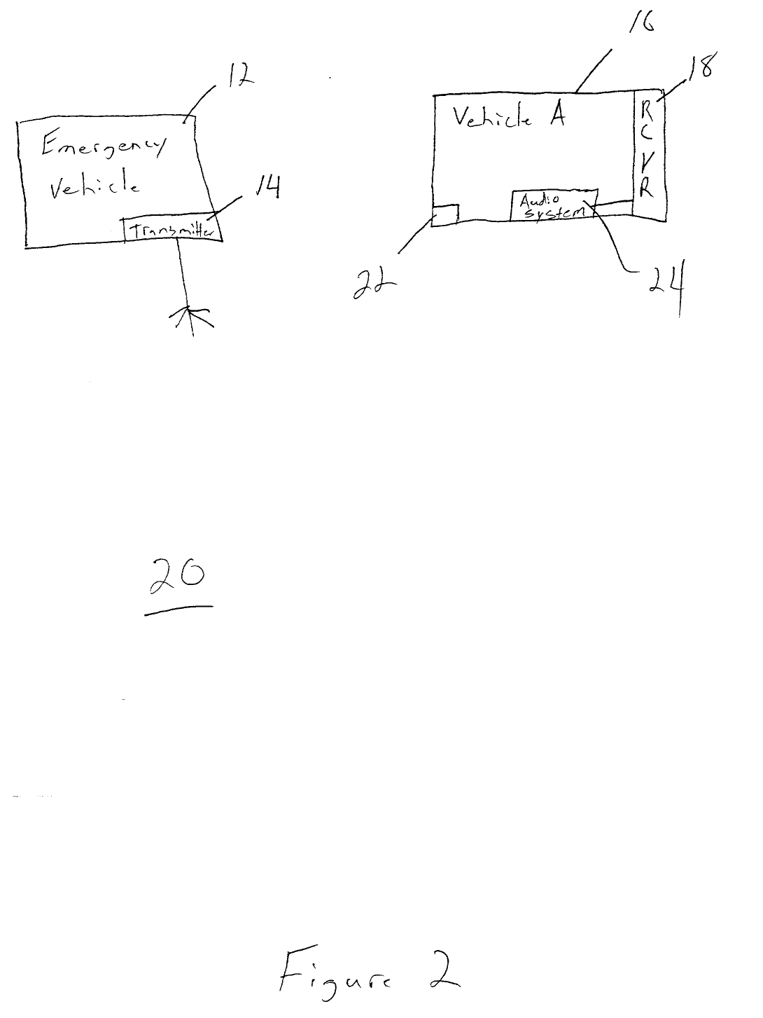

FIG. 2 illustrates an alternate preferred exemplary embodiment of the present invention. In this embodiment, the receiver unit 18 is linked with any conventional radio receiver or audio system 24 used in the automobile. This is desirable so that the volume of the radio or audio system may be automatically adjusted whenever a signal is received by receiver 18 that indicates the presence of a nearby emergency vehicle. This is accomplished by triggering the mute control or resetting the volume control. This reduction in volume in and of itself may also be useful in helping to more quickly identify the presence of the emergency vehicle. After the distance between the vehicle and the emergency vehicle increases again, the audio system preferably automatically resets to its normal operating condition.

In the preferred exemplary embodiment illustrated in FIG. 2, when such a receiver in a vehicle operating near an emergency vehicle receives a signal transmitted from the emergency vehicle, a flashing light 22 alert signal within the signal receiving vehicle may be used to indicate the presence of the emergency vehicle. It will be recognized by those skilled in the art that this flashing light 22 may be incorporated into the dashboard of the vehicle. Alternatively, the vehicle could use the audio system to generate a tone or beep which indicates the presence of an emergency vehicle. It will also be recognized that a separate audio source could also be used. The dashboard location for the flashing light 22 is preferred when factory installations have been performed.

Depending upon the selected radius or distance of transmission for the transmitting unit, this alert signal may be provided well before the time at which a driver is able to see flashing lights or hear a siren associated with the emergency vehicle. As noted above, the internal visual alert may also be used in conjunction with other audible alarms in the car in order to alert the driver of the presence of an emergency vehicle.

In the preferred exemplary embodiment, the flashing light 22 is preferably one of varying brightness or alternatively it's flash repetition rate in order to help a driver to ascertain the distance to the emergency vehicle. In such embodiment, the brightness of the light or the more rapid flashing rate of the light will indicate that the emergency vehicle is closer. Alternatively and/or in conjunction with the flashing light, an audible alarm integral to the vehicle will be activated to indicate to the driver that an emergency vehicle is traveling nearby. The audible alarm may be a voice recording and/or any other type of audible signal. In an alternate preferred embodiment, a faster blinking of a flashing light or a louder tone of the signal will indicate a closer proximity for the emergency vehicle, thereby indicating to the driver that there is a more immediate need to pull to the side of the road and allow the vehicle to pass by safely.

In such an embodiment, the relative signal strength of the signal received from the emergency vehicle is utilized in approximating the relative distance between the emergency vehicle and the automobile. This is achieved by incorporating signal strength measurement capability into the receiving unit. Once the signal strength has been determined, stored information which identifies the correlation between the received signal strength and approximate distance may be used to adjust the flashing rate of the light or the tone signal accordingly. Calibration of the system can also be used to specifically identify approximate distances whereby a signal having a particular signal strength or range of signal strengths will indicate the emergency vehicle is within approximately a specified range. Specifically, for example, the system may specify quarter-mile increments or possible distances to the emergency vehicle. This calibration may be performed at the time of installation. If this is factory installed equipment, measurements from similar vehicles made utilized in providing this information.

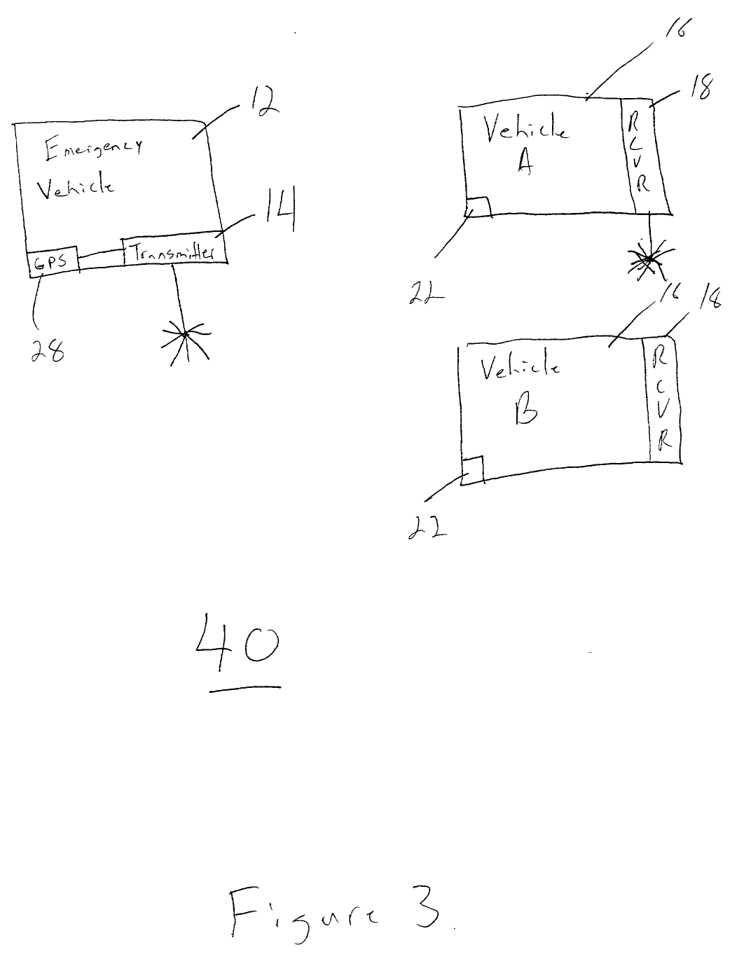

FIG. 3 illustrates an embodiment in which the transmitter 14 associated with emergency vehicle 12 transmits direction and location information to other vehicles which is shown generally at 40. In this embodiment, it is preferred that a GPS unit 28 is associated with the emergency vehicle transmitter unit so that the transmitter unit may provide GPS information regarding the specific location of the emergency vehicle and its direction of travel. Thus, this information can be specifically transmitted to nearby vehicles thereby alerting them as to the presence of the vehicle.

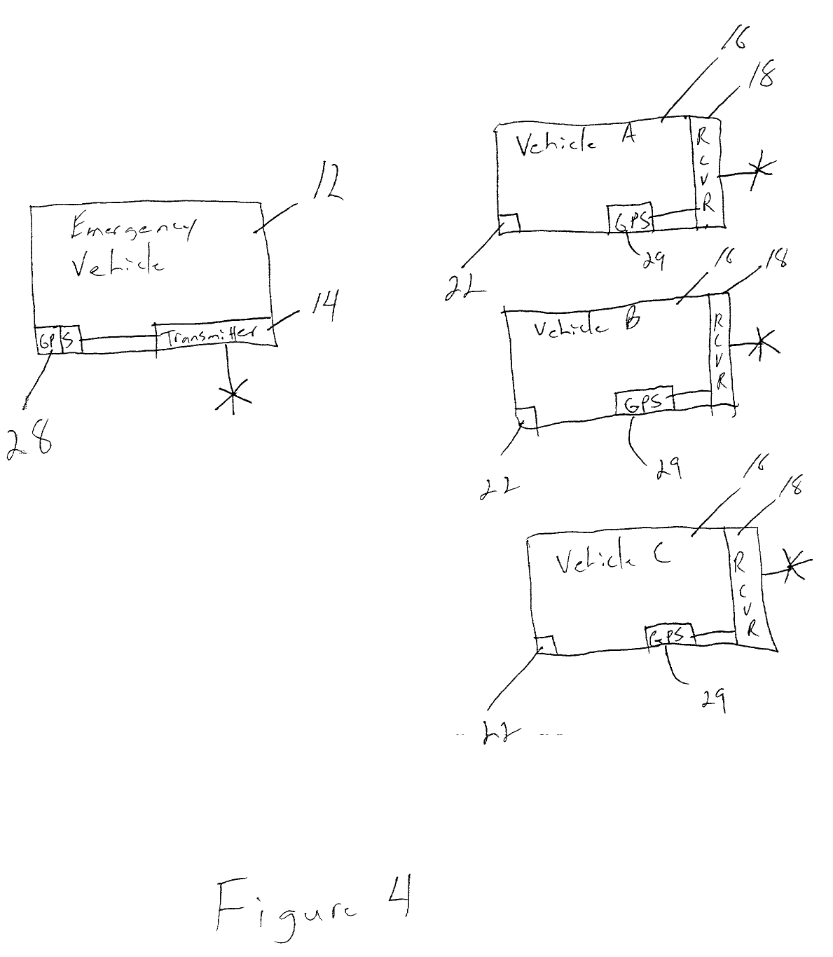

In a further, alternate exemplary embodiment of the present invention illustrated in FIG. 4, GPS information is generated by both adjacent vehicles and the emergency vehicle. This information may be compared such that irrelevant warnings may be automatically disregarded by the system. This is particularly advantageous as vehicles that are within a particular range but which are not in the path of the emergency vehicle can automatically disregard signals transmitted by the emergency vehicle. For example, if a vehicle has just passed an intersection traveling northbound and the emergency vehicle thereafter enters the intersection and begins traveling southbound on the same street, the vehicle would be able to receive and process signals containing information regarding the direction and location of the emergency vehicle but would be able to disregard this information and avoid unnecessarily alerting the driver of the vehicle regarding the presence of the emergency vehicle. It will be recognized that the direction and location information generated by the emergency vehicle may be transmitted to other vehicles and translated into voice data which indicates to the driver of other vehicles the location and direction of the emergency vehicle.

Additionally, the system is able to determine if an emergency vehicle is traveling on a particular roadway which may not be a concern to the driver. For example, if the emergency vehicle is traveling on a parallel roadway, the system will be able to determine, based on the location information that it is unnecessary to generate a warning signal within the vehicle.

In an alternate embodiment, the systems and methods of the present invention rely upon cellular telephone transmitter towers or other base stations with receiving units whereby preferably specific cell towers or base stations near the emergency vehicle will transmit signals concerning the presence of an emergency vehicle to other vehicles with receivers traveling in the area. The receive units in the other vehicles may also be connected with the conventional radio of the car such that the audio volume of the radio or other audio device may be reduced in order to prevent a driver from accidentally missing the audio signal indicating that an emergency vehicle is traveling nearby.

It will be appreciated that a variety of alternate types of transmitters may be used, however, it is preferred that an FM transmitter is used for transmission of the necessary signals operating near the FM broadcast band as noted.

A variety of systems and methods are disclosed for implementation of the present invention. It will be understood by the those skilled in the art that a variety of substitutions are possible. For example alternate location information generating systems may be used such as, for example, inertial navigation and Loran type systems. Additionally, other types of receivers and transmitters may be used by the system.

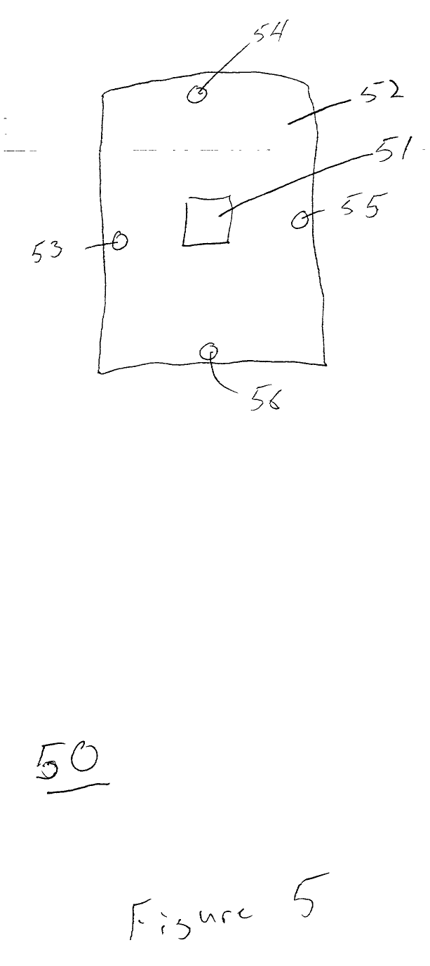

FIG. 5 illustrates an exemplary embodiment 52 of the alert mechanism described above which is shown generally at 50. In this illustration, a primary flashing light 51 is used in order to direct the attention of the driver of the vehicle traveling near an emergency vehicle to the fact that the emergency vehicle is located nearby. Additional directivity lights 53, 54, 55, 56 are used to provide an indication to the driver of the vehicle as to the general location of the emergency vehicle.

This directivity information is based upon the received signal information and may be derived from one or more directional antennas used in conjunction with the receiver.

Specifically, for example, the receive antenna is preferably comprised of a phased array antenna which is desirable swept in a circumference once an emergency vehicle signal has been received by an omnidirectional antenna. This is done in order to obtain the fundamental directional information which is then utilized to trigger the appropriate light on display 52. Specifically, for example, display 52 is oriented such that light 54 is facing the front of the vehicle and light 56 is toward the rear of the vehicle. Based on the directional information to the source of the emergency vehicle signal, the appropriate light or lights is then triggered. For example, lights 54 and 55 would be triggered if the emergency vehicle was to the right front of the vehicle. It will be appreciated that the directional indicator lights may be replaced by arrows or some other signaling mechanism to provide an indication to the driver the approximate location of the emergency vehicle. This combined with the directional information can provide a system user with a very good idea as to the relative location of the emergency vehicle. In an alternate embodiment, as noted above, where both the emergency vehicle and the user vehicle have GPS systems, GPS comparison data may be used to provide a direction to the emergency vehicle which may be then used to trigger the appropriate location light. This is accomplished by utilizing vehicle direction information which can be derived from either GPS data or an on-board compass in conjunction with GPS data for the user vehicle and a direction to the emergency vehicle based on the comparison of GPS data. As a result, the appropriate light and/or other directional signaling device may be triggered.

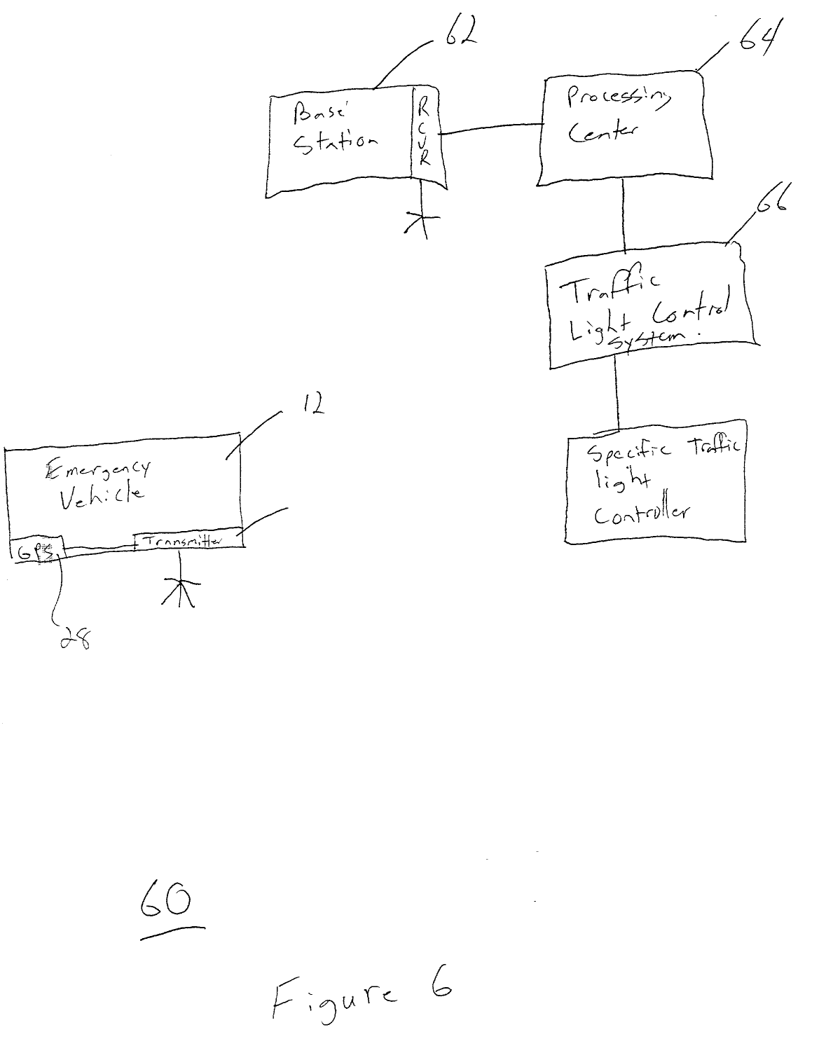

FIG. 6 illustrates yet another alternate embodiment of the present invention which is shown generally at 60. In this embodiment, when an emergency vehicle transmits its location information, one or more base stations transfers the received emergency vehicle GPS data via a receive unit 62 to processing center 64. The processing center 64 preferably has access to routing information for the emergency vehicle. This routing information for the emergency vehicle may be based on, for example, pre-planned routing information that is stored in a data base based on the original location of the emergency vehicle and ultimate destination. Additionally, this routing information can be derived based on GPS data and known map data in order to provide a route for the emergency vehicle. This routing information may be transferred to the emergency vehicle while it is in transit to its destination. Advantageously, the system utilizes the current GPS data received from the emergency vehicle in order to trigger traffic light controls in the appropriate manner so that the emergency vehicle may have the quickest transit to the emergency vehicle destination. The processing center 64 compares the known route information with the received current location information for the emergency vehicle and a database of controllable traffic light locations. It then sends a signal which triggers the appropriate traffic lights so that the emergency vehicle will not be impeded by traffic as it travels to its destination. Specifically, as illustrated in FIG. 5, the processing center 64 sends information which indicates the location of the light to be controlled and the desired traffic flow to traffic light control system 66 which then transmits the appropriate control signal commands to the traffic light controller associated with a particular light. In the preferred embodiment, the traffic lighting control system 66 is embodied in a computer network wherein each of the traffic light controllers for the intersections has an associated network address and the triggering information can be directed to the appropriate traffic light control unit based on the above calculations from the processing center and identification of the appropriate address for the particular light controller. The traffic lights may be triggered in the direction of intended travel when the emergency vehicle is from ¼ to ½ mile away or some other desired distance.

Once the vehicle has passed the controlled intersection, the processing center sends a reset command for the light through light control system 66 to reset the traffic light to normal operation.

We claim:

1. A method for alerting vehicles to the presence of an emergency vehicle comprising steps of:
transmitting a signal which indicates the presence of an emergency vehicle to a plurality of vehicles;
receiving the signal in a vehicle traveling near an emergency vehicle; and
generating an alarm signal which indicates the presence of the emergency vehicle.

2. The method of claim 1, wherein the alarm signal is comprised of a flashing light.

3. The method of claim 1, wherein the alarm signal is comprised of a recorded message.

4. The method of claim 1, wherein the alarm signal is comprised of an audible tone.

5. The method of claim 1, wherein the step of receiving the signal is comprised of a step of receiving the signal with a receiver that receives FM radio signals.

6. A method for alerting vehicles to the presence of an emergency vehicle comprising steps of:
transmitting a signal which indicates the location of an emergency vehicle to a plurality of vehicles;
receiving the signal in a vehicle traveling near an emergency vehicle; and
generating an alarm signal which indicates the presence of the emergency vehicle.

7. The method of claim 6, wherein the alarm signal is comprised of a flashing light.

8. The method of claim 6, wherein the alarm signal is comprised of a recorded message.

9. The method of claim 6, wherein the alarm signal is comprised of an audible tone.

10. The method of claim 6, wherein the step of receiving the signal is comprised of a step of receiving the signal with a receiver that receives FM radio signals.

11. The method of claim 6, wherein the location information is comprised of GPS data.

12. A method for alerting vehicles to the presence of an emergency vehicle comprising steps of:
transmitting a signal which indicates the location and direction of an emergency vehicle to a plurality of vehicles;
receiving the signal in a vehicle traveling near an emergency vehicle; and
generating an alarm signal which indicates the presence of the emergency vehicle.

13. The method of claim 12, wherein the alarm signal is comprised of a flashing light.

14. The method of claim 12, wherein the alarm signal is comprised of a recorded message.

15. The method of claim 12, wherein the alarm signal is comprised of an audible tone.

16. The method of claim 12, wherein the step of receiving the signal is comprised of a step of receiving the signal with a receiver that receives FM radio signals.

17. The method of claim 12, wherein the location information is comprised of GPS data.

18. A system for alerting vehicles to the presence of an emergency vehicle comprising:
a means for transmitting a signal which indicates the presence of an emergency vehicle to a plurality of vehicles;
a means for receiving the signal in a vehicle traveling near an emergency vehicle; and
a means for generating an alarm signal which indicates the presence of the emergency vehicle in the vehicle.

19. The system of claim 18, wherein the means for generating an alarm signal is comprised of a flashing light.

20. The system of claim 18, wherein the means for generating an alarm signal is comprised of a stored message.

21. The system of claim 18, wherein the means for generating an alarm signal is comprised of an audible tone sound source.

22. The system of claim 18, wherein the means for receiving the signal is comprised of an FM radio receiver.

23. A system for alerting vehicles to the presence of an emergency vehicle comprising:
a means for transmitting a signal which indicates the location of an emergency vehicle to a plurality of vehicles;
a means for receiving the signal in a vehicle traveling near an emergency vehicle; and
a means for generating an alarm signal which indicates the presence of the emergency vehicle.

24. The system of claim 23, wherein the means for generating an alarm signal is comprised of a flashing light.

25. The system of claim 23, wherein the means for generating an alarm signal is comprised of a stored message.

26. The system of claim 23, wherein the means for generating an alarm signal is comprised of an audible tone.

27. The system of claim 23, wherein the means for receiving the signal is comprised of an FM radio receiver.

28. The system of claim 23, wherein the location information is comprised of GPS data.

29. A system for alerting vehicles to the presence of an emergency vehicle comprising:
a means for transmitting a signal which indicates the location and direction of an emergency vehicle to a plurality of vehicles;
a means for receiving the signal in a vehicle traveling near an emergency vehicle; and
a means for generating an alarm signal which indicates the presence of the emergency vehicle.

30. The system of claim 29, wherein the means for generating an alarm signal is comprised of a flashing light.

31. The system of claim 29, wherein the means for generating an alarm signal is comprised of a stored message.

32. The system of claim 29, wherein the means for generating an alarm signal is comprised of an audible tone sound source.

33. The system of claim 29, wherein the means for receiving the signal is comprised of an FM radio receiver.

34. The system of claim 29, wherein the location information is comprised of GPS data.
